(19) United States
(12) Patent Application Publication
(10) Pub. No.: US 2003/0153850 A1
(43) Pub. Date: Aug. 14, 2003

(54) Method and apparatus for image-guided therapy

(76) Inventors: Brian J. Davis, Rochester, MN (US); Wayne N. Lajoie, Rochester, MN (US); Michael G. Herman, Rochester, MN (US); James F. Greenleaf, Rochester, MN (US)

Correspondence Address: FAEGRE & BENSON LLP, 2200 Wells Fargo Center, 90 South Seventh Street, Minneapolis, MN, 55402-3901, US

(21) Appl. No.: 10/345,832

(22) Filed: Jan. 16, 2003

Related U.S. Application Data
(60) Provisional application No. 60/349,706, filed on Jan. 16, 2002.

(51) Int. Cl. A61H 1/00

(52) U.S. Cl. 601/2

(57) ABSTRACT

A method and system for imaging and treating an internal organ of a patient is disclosed. In an illustrative method embodying the invention, a method of imaging and treating prostate cancer includes first stabilizing the prostate using a tube, with imbedded fiducial markers, inserted into the rectum of the patient and attached to an external perineal template and support. Ultrasound images of the prostate and surroundings are then taken with an ultrasound imaging probe inserted into the tube. The radioisotope seeds are implanted with the guidance of the ultrasound images. Afterwards, CT and/or fluoroscopic images are taken to examine the adequacy of the implantation. Image fusion of ultrasound and CT and/or fluoroscopic images is then achieved. If necessary, further or corrective implantation procedures can be carried out under ultrasound guidance, with follow-up CT and or fluoroscopic imaging. The process can be repeated until the implantation is deemed satisfactory.

### CROSS REFERENCE TO RELATED APPLICATIONS

The present application claims to the benefit of the U.S. Provisional Application No. 60/349,706, filed Jan. 16, 2002, which is incorporated herein by reference.

### GOVERNMENT INTEREST

This invention was made in part with government support under the National Institute of Aging research grant, R21-AG19382-01. The government therefore has certain rights in the invention.

### FIELD OF THE INVENTION

The invention relates generally to minimally invasive prostate therapies. More particularly, the invention relates to a trans-rectal ultrasound probe holder and a method for stabilizing the prostate while imaging the prostate region with multiple imaging modalities or performing other diagnostic or therapeutic procedures.

### BACKGROUND OF THE INVENTION

Minimally invasive therapies are widely practiced for treating prostate cancer. They include permanent brachytherapy, temporary high dose rate brachytherapy, cryotherapy and thermal treatments such as high-intensity focused ultrasound (HIFU). For example, it is estimated that in the year 2000, over 30,000 men underwent transperineal interstitial permanent prostate brachytherapy (TIPPB) in the United States for treatment of early stage prostate cancer. Some of these therapies are also used for non-cancerous conditions including benign prostatic hypertrophy (BPH). These treatment methods rely on image guidance to assure that the prostate or specific intraprostatic regions are effectively treated without overtreating adjacent normal structures such as the urinary bladder, rectum, neurovascular bundles, bladder neck, external urinary sphincter or urethra. The modern approach to TIPPB, for example, utilizes trans-rectal ultrasound (TRUS) guidance and sometimes C-arm fluoroscopy with post-procedure computed tomography (CT) scanning. An example of such a trans-rectal ultrasound-guided implantation device is schematically shown in FIG. 1. An ultrasound probe 110, which is to be inserted into the patient's rectum, is supported on a stepper translator 120, which moves the probe 110 along a rail 130. A template 140 for positioning the implantation needle 150 is also mounted on the rail 130. As the probe 110 is moved by the translator 120, the ultrasound images may be displayed on a monitor 160.

The effectiveness of treatment of the prostate cancer with TIPPB is dependent on the accuracy of the placement of the radioisotope pellets, or “seeds”, in and around the prostate. One of the most effective methods for determining and documenting seed distribution in and around the prostate following TIPPB is computed tomography (CT) scanning, which involves x-ray radiation. The implanted seeds, which are typically constructed with metal shells with sealed radioisotope material within them, are readily imaged by CT. However, CT is typically inferior to TRUS or MR in establishing the prostate shape and boundaries. Because the seeds may optimally be imaged by CT and the prostate by ultrasound, it is often desirable to combine TRUS and CT imaging by image fusion, i.e., constructing a composite image from both TRUS and CT images. However, common methods of TRUS imaging rely on probe manipulation and step-sectioning, which may change the position and shape of the rectum and prostate during the imaging process. Thus, with traditional TRUS technology there are limitations with respect to optimizing image fusion.

The invention disclosed herein is aimed at providing a method and apparatus for imaging and treating internal organs, including the prostate, substantially without the drawbacks of the conventional approaches.

### SUMMARY OF THE INVENTION

Generally, the invention provides an apparatus and method for imaging and treating an internal organ, such as the prostate, of a patient using multiple imaging modalities, at least one of which is achieved by an imaging probe inserted into a body cavity of the patient. The apparatus includes a structure sized to be positionable in the body cavity to permit an imaging probe applying a first imaging modality to be inserted into and withdrawn from the interior of the structure. At least a portion of the structure is substantially transparent to the imaging modality to permit imaging of the organ through the transparent portion by the imaging probe. The structure is also sufficiently sized to fix the position of the organ with respect to surrounding tissues, such that imaging of the organ by a second imaging modality can be carried out without the imaging probe applying the first modality being inserted in the structure.

### BRIEF DESCRIPTION OF THE DRAWINGS

Other objects and advantages of the invention will become apparent upon reading the following detailed description and upon reference to the drawings in which:

FIG. 1 schematically illustrates a prior art apparatus for imaging and treating the prostate;

FIG. 2 schematically shows an ultrasound probe holder according to an aspect of the invention;

FIG. 3 schematically shows in more detail a portion of the holder shown in FIG. 2, which portion includes the beads serving as fiducial markers;

FIG. 4(a) schematically shows another view of the holder shown in FIG. 2;

FIG. 4(b) schematically shows a disassembled view of the holder shown in FIG. 2;

FIG. 5 schematically shows an ultrasound probe holder, including an implantation template, according to another aspect of the invention;

FIG. 6 schematically shows an ultrasound-guided implantation system utilizing the probe holder shown in FIG. 5;

FIG. 7 shows a CT image of a cross-section of the tube portion of an ultrasound probe holder such as the one shown in FIG. 2. The cross-section passes through a pair of 1.0-mm stainless steel balls imbedded in the tube wall;

FIG. 8 shows a “coronal”, or top-view, digitally reconstructed radiograph (DRR), computed from a CT image data set, of the probe holder imaged as shown in FIG. 7;

FIG. 9 shows a similar CT image as FIG. 7, but taken with the probe holder inserted into a phantom;

FIG. 10 shows a cross-sectional CT image of a phantom with a probe holder inserted and radioisotope seed implanted; the cross-section does not pass through any fiducial markers;

FIG. 11 shows a cross-sectional CT image of a CT phantom with a probe holder inserted and radioisotope seed implanted; the cross-section passes through a pair of fiducial markers;

FIG. 12 shows a top-view digitally reconstructed radiography (DRR) image of a CT phantom with a probe holder inserted and “dummy” seeds, which are metal pellets that contain no radioisotopes but are otherwise the same as radioisotope seeds, implanted;

FIG. 13 shows a lateral-view DRR image of a CT phantom with a probe holder inserted and “dummy” seeds implanted, as described above;

FIG. 14 shows an ultrasound image of an ultrasound prostate phantom that can also be used as a phantom for CT, MRI and fluoroscopy; and

FIG. 15 shows a Fluoroscopy image of the prostate region of a cadaver after the radioisotope seeds were implanted; the ultrasound probe holder such as that shown in FIG. 5 and implanted seeds are visible in the image.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

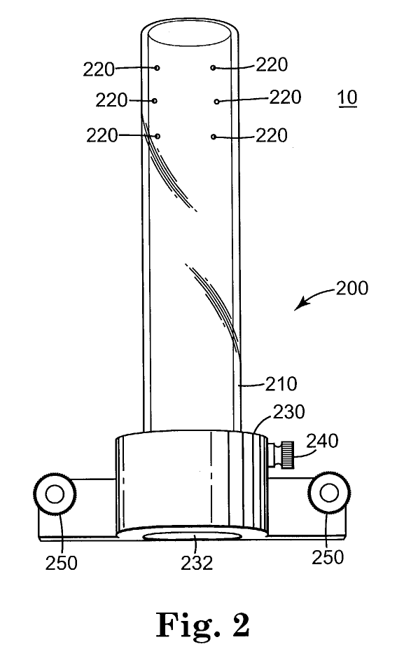

Referring to FIG. 2, an illustrative embodiment of the invention is an ultrasound probe holder 10 for TRUS applications. The holder includes an assembly 200, which includes a thin-walled tube 210 made of polycarbonate. The tube is about 11.4 cm in length and has an outside diameter of about 25 mm and wall thickness of about 1.6 mm. The length of the tube is chosen to be sufficiently long to (1) allow insertion of the TRUS probe to depths adequate for imaging the prostate and surrounding tissues and (2) exert a pressure on the prostate region to stabilize the rectum and prostate so that they do not move as the TRUS probe is operated within the tube. The inside diameter of the tube is chosen to be slightly larger than a TRUS probe so that the tube can receive the probe and allow the probe to move freely within the tube. The outside diameter of the tube is chosen so that the tube can be safely inserted into a patient's rectum. The tube material was chosen to ensure that the tube wall, at least in the portion through which ultrasound images are taken, is substantially ultrasound-transparent. In the context of this application, “substantially transparent” under a given imaging modality means that imaging through the material results in sufficiently small perturbations in the transmitted or received signals to produces images of acceptable quality for medical purposes, preferably with no visible distortion of the images. In the above-illustrated embodiment, where an ultrasound imaging probe is used, the polycarbonate tube wall, which is similar in acoustic impedance to water and produces no visible distortion of ultrasound images, is substantially transparent to ultrasound.

It should be evident to those skilled in the art that the material and size of the tube can be different from those described above as examples, depending on factors including the imaging modality, size of relevant anatomy of the patient and size of the imaging probe. Examples of other imaging modalities include magnetic resonance imaging (MRI), in which case an endorectal coil for MR imaging can be inserted into the tube 210 for enhanced MRI image quality. Examples of other materials suitable to ultrasound imaging include polymethylmethacrylate and polystyrene. Examples of other procedures include transvaginal, transesophageal, transurethral and transoral procedures. It should also be evident to those skilled in the art that although a solid tube 210 is used in the illustrative embodiment for receiving an imaging probe and stabilizing the internal organs of interest, other devices can be used to achieve the same purposes. For example, tubes with perforations on its walls for specific applications and speculums made of suitable materials can be used.

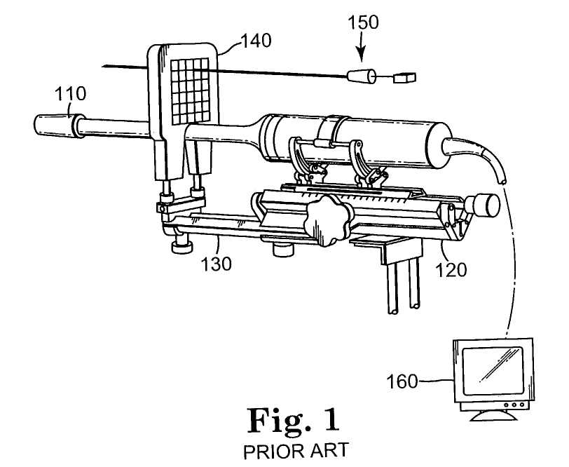

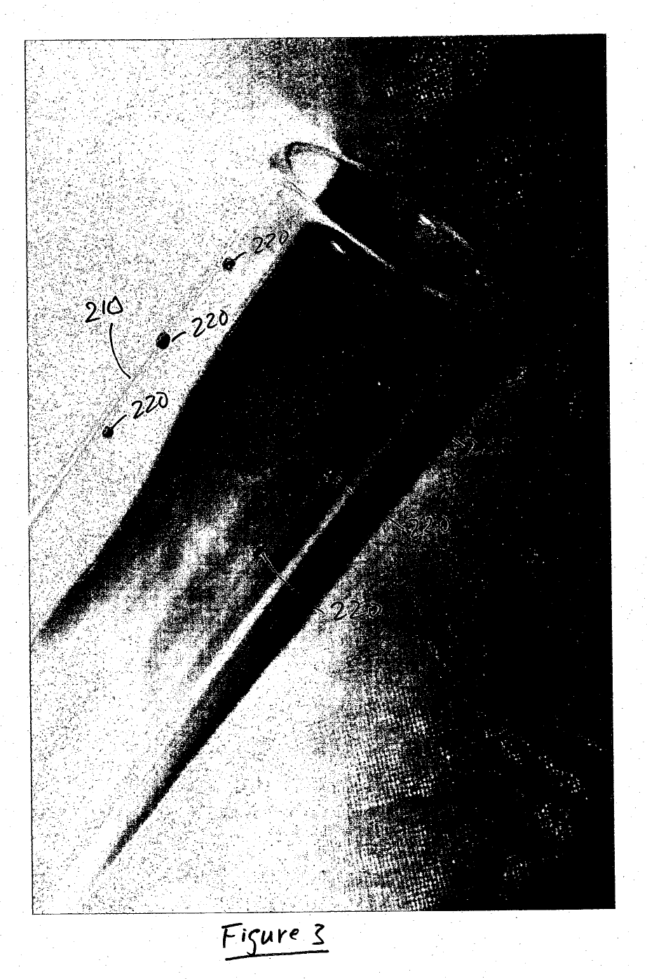

Referring again to FIG. 2, and in more detail to FIG. 3, the tube 210 in the illustrative embodiment also includes imbedded fiducial markers that are visible, i.e., form contrast with their surroundings, under ultrasound and a second contemplated imaging modality, such as CT, MRI or fluoroscopy. In the embodiment illustrated in FIGS. 1 and 2, stainless steel balls 220 are used to be visible under CT and fluoroscopy. The balls 220 are imbedded by gluing them in the holes in the tube 210. Holes about 1.2 mm in diameter are drilled in the polycarbonate tube. The holes form two parallel rows along the lengthwise direction of the tube 210. The two rows are about 75° apart about the longitudinal axis of the tube 210. The holes in each row are spaced about 10 mm apart. The holes in the two rows form pairs such that a straight line connecting the two holes in each pair is perpendicular to the longitudinal axis of the tube 210. Stainless steel balls of about 1.0 mm in diameter are affixed inside the holes with a thin layer of glue, preferably free of air bubbles or any other inclusions that would interfere with ultrasound transmission.

It should be evident to those skilled in the art that the choices of material, number, sizes and locations of the fiducial markers can be varied according to specific applications. For example, MR contrast agents, including gadolinium-impregnated materials, can be used as fiducial markers for MRI.

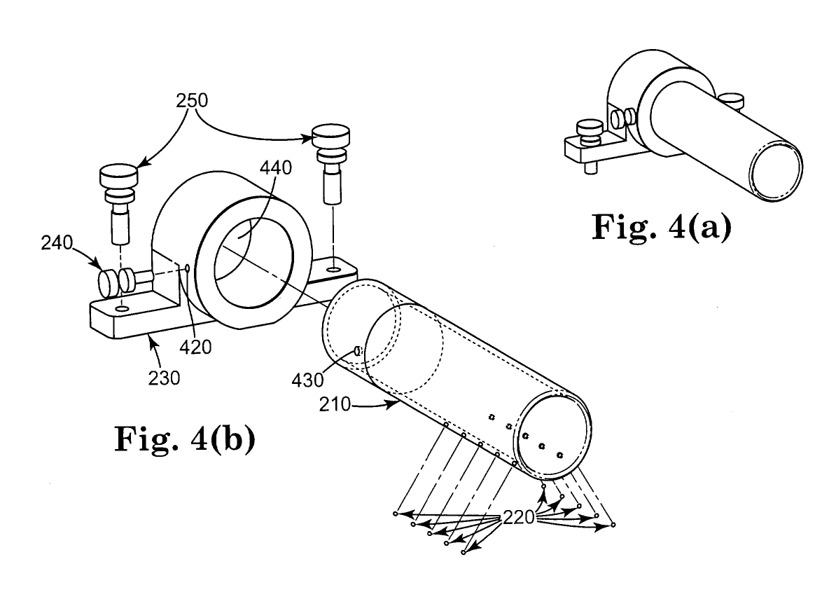

Referring to FIGS. 2 and 4(b), the probe holder 200 can be mounted on a pillow block 230 so as to be attached to the remainder of a TRUS apparatus (see below). The pillow block has a cylindrical hole 410 that allows within it a snug slip fit of one end of the tube 210. A thumbscrew 240 is fed through a threaded hole 420 to engage the tip of the thumbscrew 240 in a hole 430 in the tube 210 to lock the tube 210 to the pillow block 230. Two additional thumbscrews 250 can be used to attach the pillow block to the remainder of the TRUS apparatus. The finished assembly 200 is shown from another perspective in FIG. 4(a).

The pillow block 230 and thumbscrews 240, 250 are made of Delrin® but can be made of any suitable material for attachment to the tube 210. Examples of such materials include other polymeric materials, metals and ceramic materials.

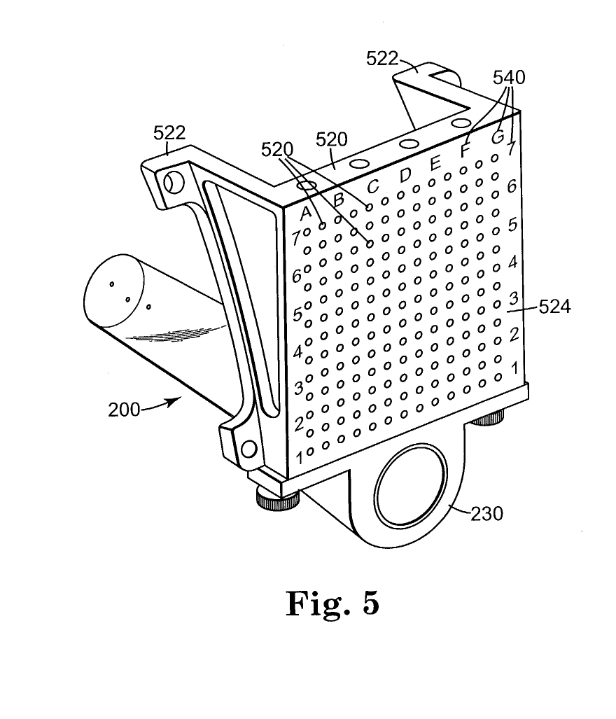

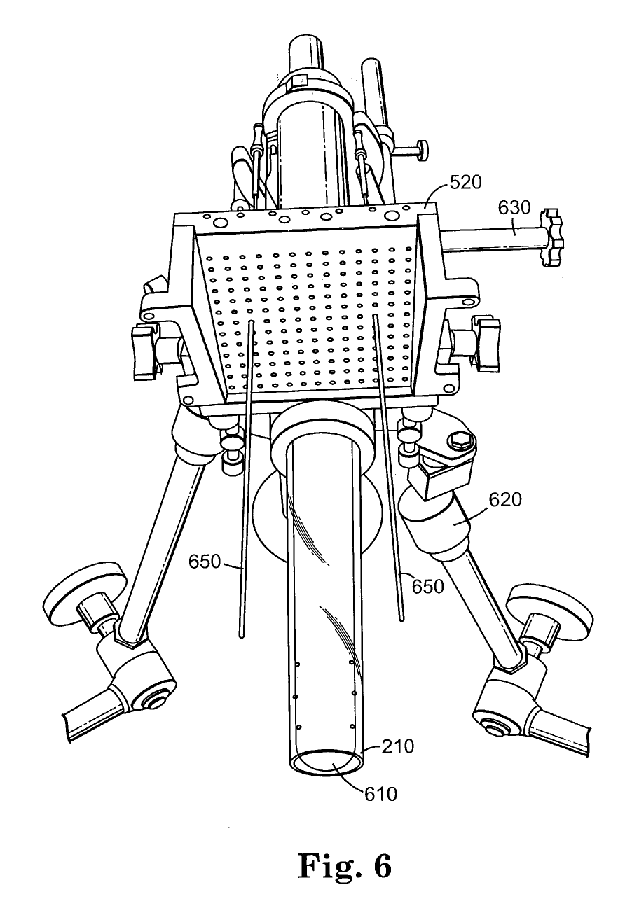

Referring to FIG. 5, the assembly 200 is attached to a template 520 by the thumbscrews 250. The template 520 forms two flanges 522 that rest on the patient's body (optionally through a cushion pad, not shown, or with the template sutured to the body) when the tube 210 is fully inserted into the patient. The plate portion 524 is perpendicular to the tube 210 in the illustrative embodiment but can also be oriented differently with respect to the tube 210 to best suit the specific application. There is a matrix of holes 530 drilled through the plate portion 524. The holes 530 are identifiable by the column and row indices 540. In further reference to FIG. 6, the holes 530 act as guides for aiming implantation needles 650 or other surgical instruments at specific locations in the patient's body.

The template 520 is made of an acrylic material but also can be made of other materials known to those skilled in the art to be suitable for such purposes. Examples include other polymeric materials, metals and ceramic materials.

Referring again to FIG. 6, the assembly shown in FIG. 5 is incorporated into a TRUS apparatus. In particular, the holder assembly 200 and the template 520 are attached to an adjustable frame 620, which can be in turn attached to the patient bed (not shown). Also attached to the frame 620 is a TRUS probe 610, shown in FIG. 6 positioned inside the tube 210, and operated by a probe positioner 630 known in the art.

In operation, a patient can be positioned on a patient bed fitted with a TRUS apparatus such as that shown in FIG. 6. The tube 210 is inserted into the patient's rectum until the template 520 is positioned sufficiently close to the region of patient anatomy targeted for implantation or other procedures. At this point, the tube exerts a sufficient pressure on the prostate and surrounding region to stabilize them. With the tube 210 and template 520 remaining stationary relative to the patient, the TRUS probe 610 can be inserted or otherwise manipulated within the tube to provide images of the prostate and surrounding regions while radioisotope seeds are implanted under guidance by the images by the needles 650. It is noted that the prostate and surrounding region of interest remain fixed while the TRUS probe is manipulated and seeds are implanted.

Following the planned implantation of radioisotope seeds, CT, MRI or fluoroscopy imaging can be used to examine the distribution of the seeds while the tube 210 remains in place. The TRUS probe is preferably removed during CT, MRI, fluoroscopy or other types of follow-up imaging so that the probe itself does not interfere or obscure the follow-up images. Without such interference from the probe, the process of creating composite images from ultrasound images and images by another modality become easier. If a desired distribution pattern has not been achieved, further implantation or manipulation of seeds can be carried out under the guidance of TRUS. The process can be repeated until a desired pattern is reached.

Once a TRUS image and CT image of the same view and showing the same fiducial markers are obtained, the two images can be combined in a computer, either manually or automatically, using methods known in the art to create a composite image showing optimally imaged seeds and optimally imaged internal organs of interest.

The device provides a means when used with the perineal template 520 and several needles 650 implanted in the prostate through the perineal template 520 to stabilize the prostate and form a coordinate system whereby additional therapy can be directed in relation to areas already treated. For example, in permanent prostate brachytherapy, if CT evaluation of the seed distribution relative to the prostate determines that there are areas which are under-treated or where no seeds were placed, then additional radioactive seeds may be accurately placed using the probe holder and template as guides and a means by which to stabilize the prostate.

### EXAMPLES

To demonstrate the use of fiducial markers in both TRUS and follow-up imaging using a second imaging modality, the following experiments were carried out.

### Example 1

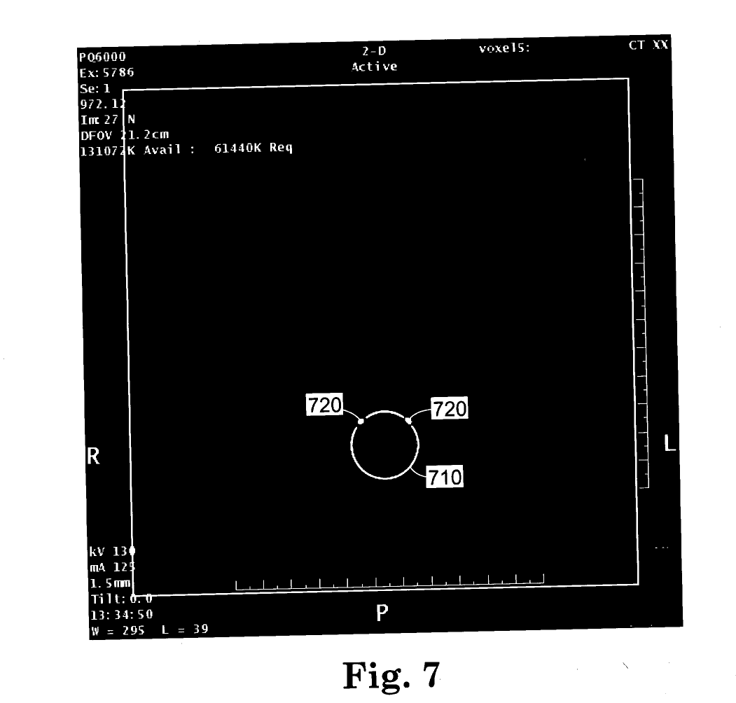

A freestanding probe holder with a polycarbonate tube imbedded with two rows of 1.0-mm stainless steel balls as fiducial markers as described above and shown in FIGS. 2, 3, 4 and 5 was imaged using CT in a scanner with a 60-cm bore and an 18-cm field of view. The resolution used was 512×512 and 3 mm slice spacing. The voxel size was 0.35×0.35×3 mm. An “axial” cross-sectional view along the longitudinal axis of the tube is shown in FIG. 7, which shows contrast for both a pair of markers 720 and the wall of the tube 710.

### Example 2

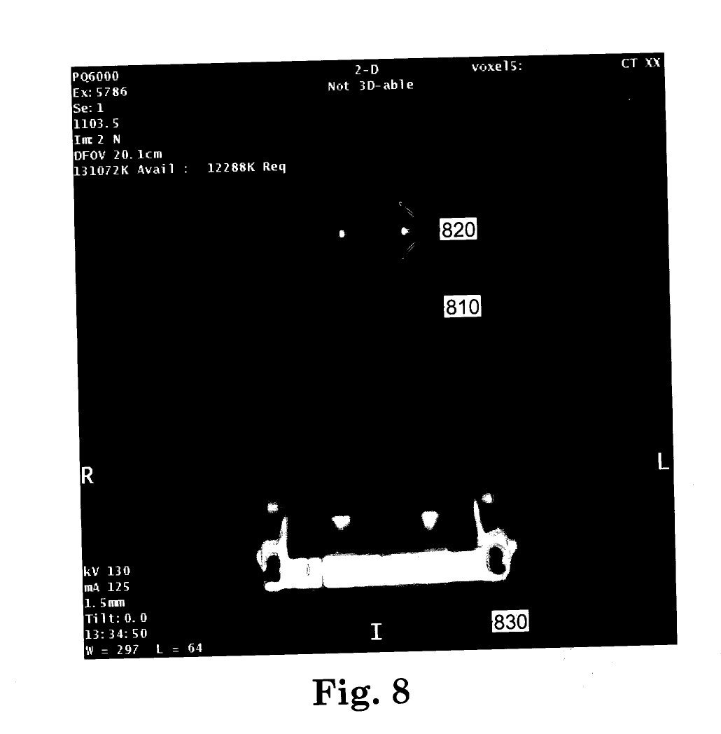

A freestanding probe holder with a polycarbonate tube imbedded with two rows of 1.0-mm stainless steel balls as fiducial markers as described above and shown in FIGS. 2, 3, 4 and 5 was imaged using CT. A “coronal” DRR view, computed for the CT data set, along an axis bisecting the template 520 between the flanges 522 is shown in FIG. 8, which shows contrast for both the markers 820 and the tube 810.

### Example 3

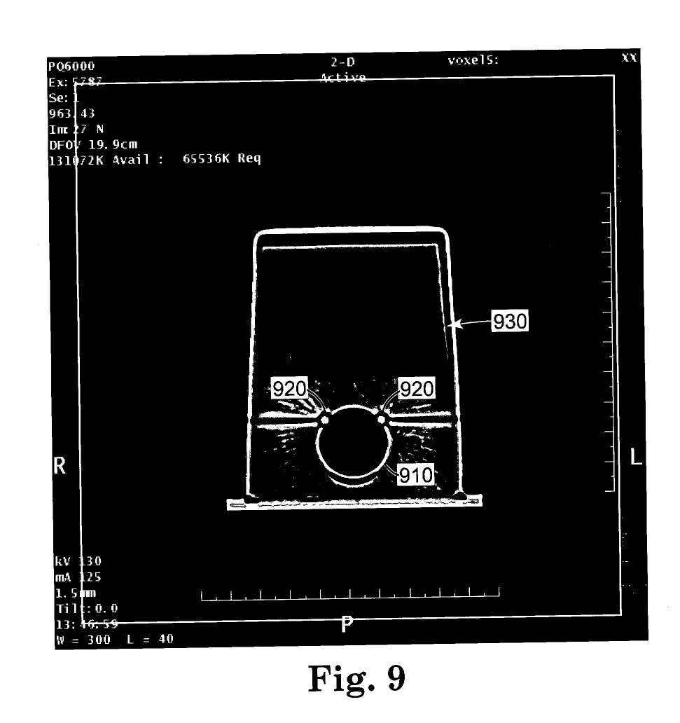

A probe holder with a polycarbonate tube imbedded with two rows of 1.0-mm stainless steel balls as fiducial markers as described above and shown in FIGS. 2, 3, 4 and 5 was imaged inside a CT phantom using CT. An “axial” cross-sectional view along the longitudinal axis of the tube is shown in FIG. 9, which shows contrast for both a pair of markers 920 and the wall of the tube 910. The CT phantom also produced contrast 930.

### Example 4

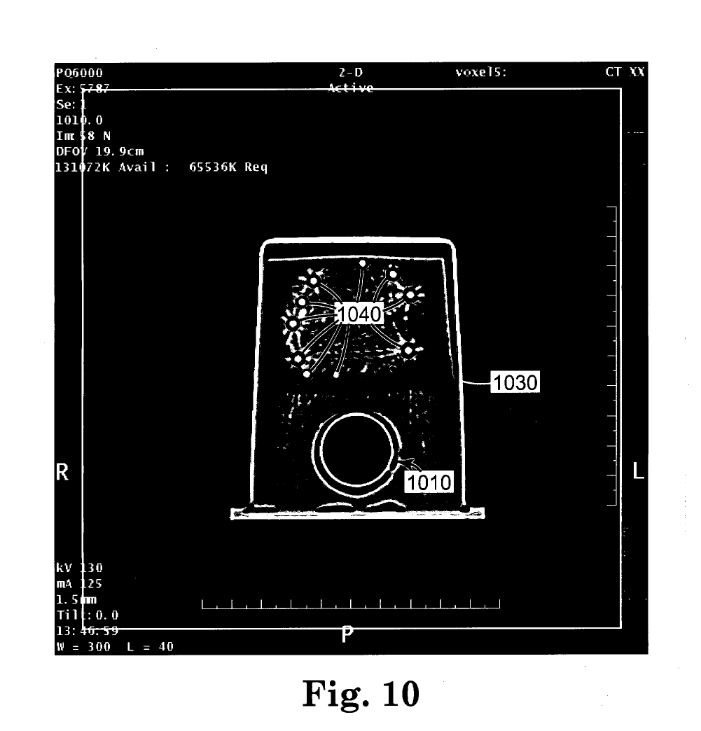

A probe holder with a polycarbonate tube imbedded with two rows of 1.0-mm stainless steel balls as fiducial markers as described above and shown in FIGS. 2, 3, 4 and 5 was imaged inside a CT phantom using CT. The phantom was also implanted with “dummy” seeds, which are metal pellets that contain no radioisotopes but are otherwise the same as radioisotope seeds. An “axial” cross-sectional view along the longitudinal axis of the tube is shown in FIG. 10, which shows contrast for both the seeds 1040 and the wall of the tube 1010. The CT phantom also produced contrast 1030. There was no contrast for any markers because they were located outside the imaged plane.

### Example 5

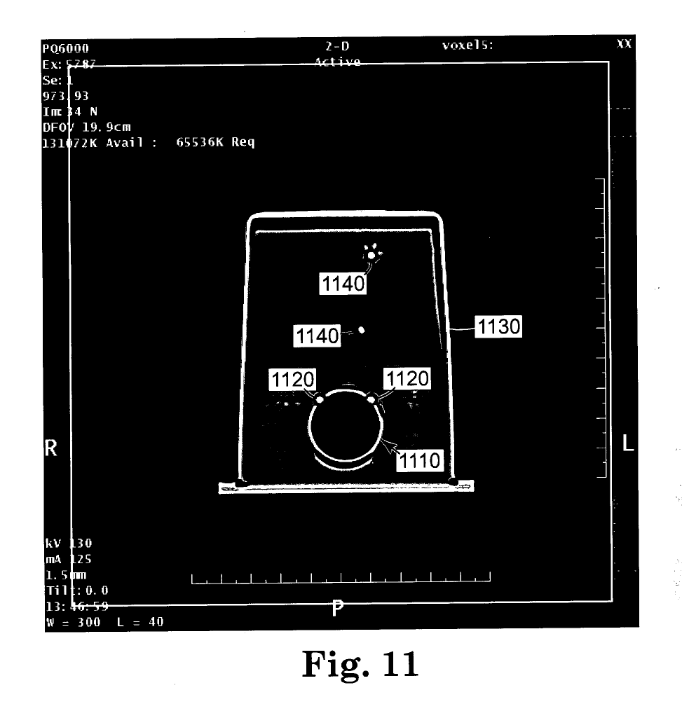

A probe holder with a polycarbonate tube imbedded with two rows of 1.0-mm stainless steel balls as fiducial markers as described above and shown in FIGS. 2, 3, 4 and 5 was imaged inside a CT phantom using CT. An “axial” cross-sectional view along the longitudinal axis of the tube is shown in FIG. 11, which shows contrast for a pair of markers 1120, the wall of the tube 1110 and the seeds 1140. The CT phantom also produced contrast 1130.

### Example 6

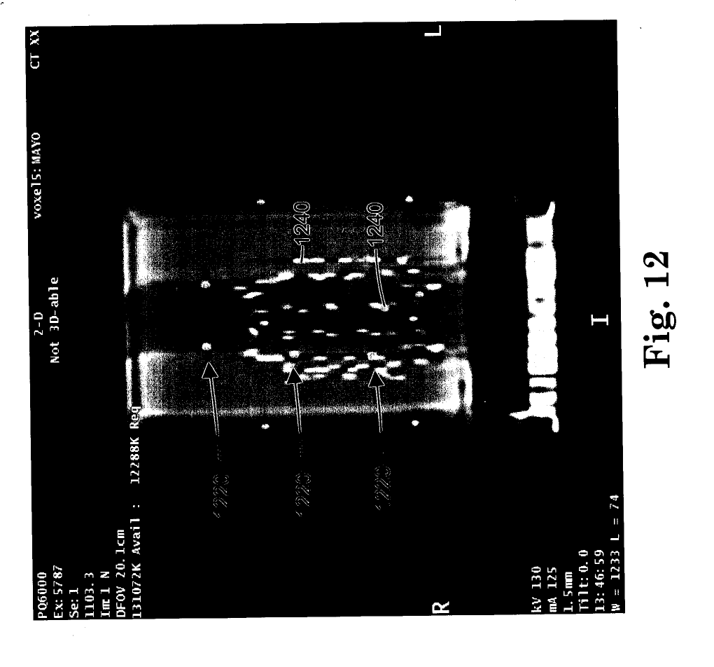

A probe holder with a polycarbonate tube imbedded with two rows of 1.0-mm stainless steel balls as fiducial markers as described above and shown in FIGS. 2, 3, 4 and 5 was imaged inside a CT phantom using CT. A “coronal” DRR view, computed from the CT data set is shown in FIG. 12, which shows contrast for the markers 1220 as compared to that for the implanted seeds 1240.

### Example 7

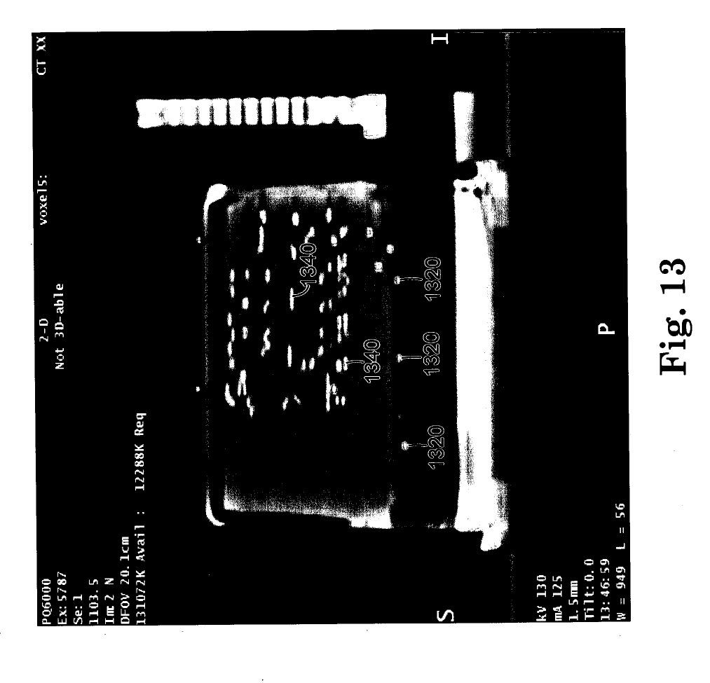

A probe holder with a polycarbonate tube imbedded with two rows of 1.0-mm stainless steel balls as fiducial markers as described above and shown in FIGS. 2, 3, 4 and 5 was imaged inside a ultrasound prostate phantom using CT. A “sagittal”, or lateral, DRR view, computed from the CT data set along an axis perpendicular to the tube 210 and the flanges 522 is shown in FIG. 13, which shows contrast for the markers 1320 as compared to that for the implanted seeds 1340. The CT phantom also produced contrast 1330.

### Example 8

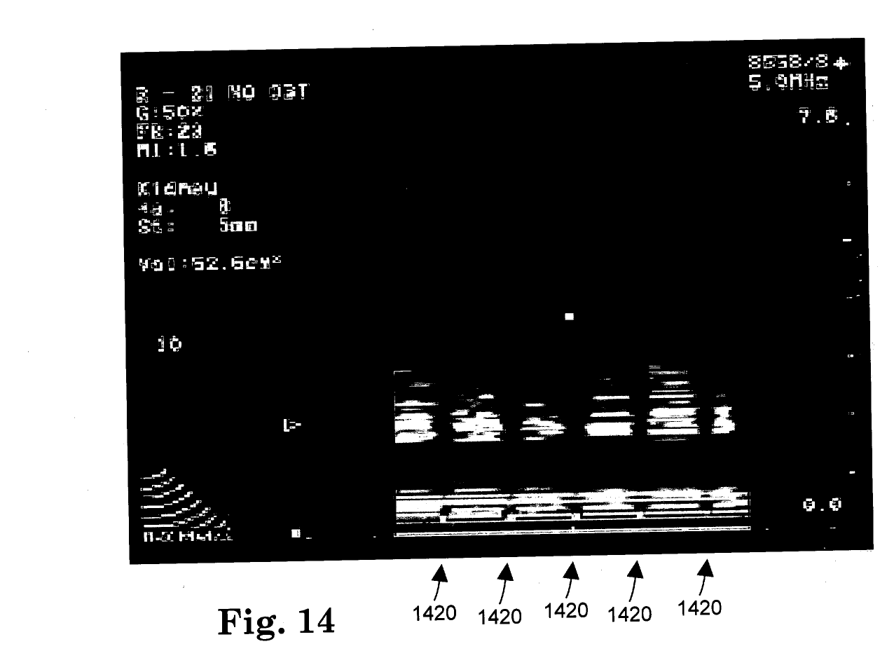

A ultrasound image was taken of a probe holder, having a polycarbonate tube imbedded with two rows of 1.0-mm stainless steel balls as fiducial markers as described above and shown in FIGS. 2, 3, 4 and 5, positioned inside both a phantom and a cadaver. A “sagittal” view is shown in FIG. 14, which shows contrast for both a row of markers 1320 and the ultrasound prostate phantom superior to the markers.

### Example 9

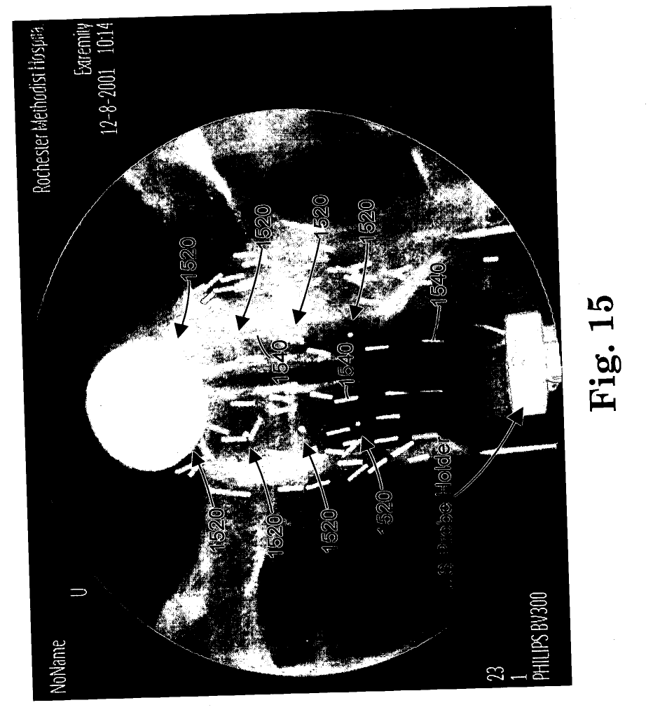

A probe holder with a polycarbonate tube imbedded with two rows of 1.0-mm stainless steel balls as fiducial markers as described above and shown in FIGS. 2, 3, 4 and 5 was imaged inside a human cadaver using fluoroscopy. Radioisotope seeds of approximately 4.5 mm long and 800 micrometers across were implanted in the imaged region of the cadaver. A coronal view is shown in FIG. 15, which shows contrast for both the markers 1520 and the seeds 1540. The object shown as the bright, round pattern near the top of the image was a foley balloon, filled with a radio-opaque material, within the urinary bladder. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. An apparatus for aiding prostate imaging and treatment, the apparatus comprising a structure sized to be insertable into a patient's rectum and to permit an ultrasound imaging probe to be inserted into and withdrawn from the interior of the structure, the structure being adapted to be positioned to fix the position of the prostate with respect to surrounding tissue, at least a portion of the structure being substantially ultrasound-transparent to permit imaging of the prostate through the portion by the ultrasound imaging probe.

2. The apparatus of claim 1, wherein the structure is sufficiently long to be inserted in to a patient's rectum to exert a sufficient pressure on the patient's prostate to substantially prevent the prostate from moving relative to the structure while being imaged by the ultrasound imaging probe.

3. The apparatus of claim 1, wherein the ultrasound-transparent portion includes a substantially ultrasound-transparent material.

4. The apparatus of claim 3, wherein the substantially ultrasound-transparent material comprises polymer.

5. The apparatus of claim 3, wherein the structure further comprises a fiducial marker disposed within the substantially ultrasound-transparent material, the marker forming contrast with the substantially ultrasound-transparent material in an ultrasound image.

6. The apparatus of claim 3, wherein the structure comprises a plurality of fiducial markers spaced apart from each other and disposed within the ultrasound-transparent material, the markers forming contrast with the ultrasound-transparent material in an ultrasound image.

7. The apparatus of claim 1, further comprising a template attached to the structure, the template including guides for aiming surgical instruments at predetermined locations in the patient's body.

8. The apparatus of claim 7, further comprising a positioner linked to the structure and template and adapted to move the structure and template relative to the patient's body.

9. The apparatus of claim 5, wherein the fiducial marker and the substantially ultrasound-transparent material are chosen to form contrast with each other under a second imaging modality.

10. The apparatus of claim 9, wherein the fiducial marker and the ultrasound-transparent material are chosen to form contrast with each other under X-ray imaging.

11. The apparatus of claim 9, wherein the fiducial marker and the ultrasound-transparent material are chosen to form contrast with each other under magnetic resonance imaging.

12. The apparatus of claim 9, wherein the fiducial marker and the ultrasound-transparent material are chosen to form contrast with each other under fluoroscopy.

13. An apparatus for aiding imaging of an organ of a patient by an imaging modality, the application of the imaging modality to be accomplished by inserting an imaging probe through a body cavity of the patient, the apparatus comprising a structure sized to be positionable in the body cavity to permit an imaging probe applying the imaging modality to be inserted into and withdrawn from the interior of the structure, at least a portion of the structure being substantially transparent to the imaging modality to permit imaging of the organ through the transparent portion by the imaging probe.

14. The apparatus of claim 13, wherein in structure comprises a tube sized to be insertable into the body cavity to permit an imaging probe applying the imaging modality to be freely inserted into and withdrawn from the interior of the tube, at least a portion of the tube being substantially transparent to the imaging modality to permit imaging of the organ through the transparent portion by the imaging probe.

15. A method of imaging and treating of an organ of a patient, the method comprising:
(a) inserting into a body cavity of the patient a hollow device;
(b) imaging, using a first imaging modality, the organ by inserting into the hollow device an imaging probe adapted to apply the first imaging modality; and
(c) imaging the organ using a second imaging modality.

16. The method of claim 15, further comprising stabilizing the organ by applying pressure to the organ using the hollow device inserted in step (a).

17. The method of claim 16, further comprising performing a medical procedure on the patient under the guidance of the first imaging modality applied in step (b).

18. The method of claim 17, wherein the step of performing a medical procedure comprises implanting radioactive seeds in or near the organ.

19. The method of claim 15, further comprising placing into the patient's body a plurality of fiducial markers visible under both the first and second imaging modalities.

20. The method of claim 19, further comprising combining an image obtained in step (b) with an image obtained in step (c) by fusing images of the plurality of markers in the image obtained in step (b) with the images of the plurality of markers in the image obtained in step (c).

21. The method of claim 15, wherein step (a) comprises inserting a tube that includes at least a portion made of an ultrasound-transparent material, and wherein step (b) comprises imaging, using ultrasound imaging, the organ by inserting into the tube an ultrasound imaging probe.

22. The method of claim 21, wherein the step of inserting a tube comprises inserting a tube into the patient's rectum, and wherein the step of imaging using ultrasound imaging comprises imaging the prostate of the patient.

23. The method of claim 22, further comprising stabilizing the prostate of the patient using the inserted tube.

24. The method of claim 23, wherein step (c) comprises imaging using x-ray tomography, magnetic resonance imaging or fluoroscopy.

25. A method of imaging and treating of an organ of a patient, the method comprising:
(a) stabilizing the organ;
(b) imaging, using a first imaging modality, the organ from inside a body cavity of the patient; and
(c) imaging the organ using a second imaging modality.

26. The method of claim 25, further comprising performing a medical procedure on the patient under the guidance of the first imaging modality carried out in step (b), wherein step (c) is carried out after the medical procedure.
